(19) United States
(12) Patent Application Publication
(10) Pub. No.: US 2022/0151004 A1
(43) Pub. Date: May 12, 2022

(54) AVOIDING TRANSMISSION OF UNNECESSARY 5GSM MESSAGE

(71) Applicant: Telefonaktiebolaget LM Ericsson (publ), Stockholm (SE)

(72) Inventors: Ivo Sedlacek, Hovorcovice (CZ); Peter Hedman, Helsingborg (SE); Paul Schliwa-Bertling, Ljungsbro (SE); Kaj Johansson, Göteborg (SE); Nianshan Shi, Järfälla (SE)

(21) Appl. No.: 17/432,033

(22) PCT Filed: Feb. 18, 2020
(86) PCT No.: PCT/IB2020/051342

§ 371 Date: Aug. 18, 2021

Related U.S. Application Data
(60) Provisional application No. 62/807,078, filed on Feb. 18, 2019.

(51) Int. Cl. H04W 76/18; H04W 76/12; H04W 8/08

(52) U.S. Cl. CPC H04W 76/18; H04W 8/082; H04W 76/12

(57) ABSTRACT

Avoiding transmission of unnecessary 5G session management (SM) messages in a cellular communications system is disclosed. In one embodiment, a method performed by a Session Management Function (SMF) comprises determining that a non-access stratum (NAS) message carrying a Protocol Data Unit (PDU) session establishment accept indication was not sent to a user equipment (UE) by a radio access network (RAN). The method further comprises, responsive to determining that the NAS message carrying the PDU session establishment accept indication was not sent to the UE, sending a PDU session establishment reject indication to the UE. In some embodiments, determining that the NAS message carrying the PDU session establishment accept indication was not sent to the UE comprises receiving an Nsmf_PDUSession_UpdateSMContext request comprising a cause, and determining that the NAS message carrying the PDU session establishment accept indication was not sent to the UE based on the cause.

### RELATED APPLICATIONS

This application claims the benefit of provisional patent application Ser. No. 62/807,078, filed Feb. 18, 2019, the disclosure of which is hereby incorporated herein by reference in its entirety.

### TECHNICAL FIELD

The present disclosure relates to Protocol Data Unit (PDU) session establishment in a cellular communications system.

### BACKGROUND

The Third Generation Partnership Project (3GPP) Technical Specification (TS) 23.502 provides a procedure for user equipment (UE)-requested Protocol Data Unit (PDU) Session Establishment for non-roaming and roaming with local breakout. The baseline procedure shown below in table 1 and illustrated in FIGS. 1A and 1B is excerpted from TS 23.502, subclause 4.3.2.2.1, and describes the procedure as follows (note that the procedure assumes that the UE has already registered on the Access and Mobility Management Function (AMF), and thus, unless the UE is Emergency Registered, the AMF has already retrieved the user subscription data from a Unified Data Management (UDM) provider):

TABLE 1

| | |
|---|---|
| 1. | From UE to AMF: NAS Message (S-NSSAI(s), DNN, PDU Session ID, Request type, Old |
| | PDU Session ID, N1 SM container (PDU Session Establishment Request)). |
| | In order to establish a new PDU Session, the UE generates a new PDU Session ID. |
| | The UE initiates the UE Requested PDU Session Establishment procedure by the |
| | transmission of a NAS message containing a PDU Session Establishment Request within |
| | the N1 SM container. The PDU Session Establishment Request includes a PDU session ID, |
| | Requested PDU Session Type, a Requested SSC mode, 5GSM Capability PCO, SM PDU |
| | DN Request Container, Number Of Packet Filters, and optionally Always-on PDU Session |
| | Requested. |
| | The Request Type indicates “Initial request” if the PDU Session Establishment is a request |
| | to establish a new PDU Session and indicates “Existing PDU Session” if the request refers |
| | to an existing PDU Session switching between 3GPP access and non-3GPP access or to a |
| | PDU Session handover from an existing PDN connection in EPC. If the request refers to an |
| | existing PDN connection in EPC, the S-NSSAI is set as described in TS 23.501 [1] |
| | clause 5.15.7.2 |
| | When Emergency service is required and an Emergency PDU Session is not already |
| | established, a UE shall initiate the UE Requested PDU Session Establishment procedure |
| | with a Request Type indicating “Emergency Request”. |
| | The Request Type indicates “Emergency Request” if the PDU Session Establishment is a |
| | request to establish a PDU Session for Emergency services. The Request Type indicates |
| | “Existing Emergency PDU Session” if the request refers to an existing PDU Session for |
| | Emergency services switching between 3GPP access and non-3GPP access or to a PDU |
| | Session handover from an existing PDN connection for Emergency services in EPC. |
| | The 5GSM Core Network Capability is provided by the UE and handled by SMF as |
| | defined in TS 23.501 [1] clause 5.4.4b. The 5GSM Capability also includes the UE |
| | Integrity Protection Maximum Data Rate. |
| | The Number Of Packet Filters indicates the number of supported packet filters for signalled |
| | QoS rules for the PDU Session that is being established. The number of packet filters |
| | indicated by the UE is valid for the lifetime of the PDU Session. |
| | The NAS message sent by the UE is encapsulated by the AN in a N2 message towards the |
| | AMF that should include User location information and Access Type Information. |
| | The PDU Session Establishment Request message may contain SM PDU DN Request |
| | Container containing information for the PDU Session authorization by the external DN. |
| | The UE includes the S-NSSAI from the Allowed NSSAI of the current access type. If the |
| | Mapping of Allowed NSSAI was provided to the UE, the UE shall provide both the S- |
| | NSSAI from the Allowed NSSAI and the corresponding S-NSSAI from the Mapping Of |
| | Allowed NSSAI. |
| | If the procedure is triggered for SSC mode 3 operation, the UE shall also include the Old |
| | PDU Session ID which indicates the PDU Session ID of the on-going PDU Session to be |
| | released, in NAS message. The Old PDU Session ID is an optional parameter which is |
| | included only in this case. |
| | The AMF receives from the AN the NAS SM message (built in step 1) together with User |
| | Location Information (e.g. Cell Id in case of the NG-RAN). |
| | The UE shall not trigger a PDU Session establishment for a PDU Session corresponding to |
| | a LADN when the UE is outside the area of availability of the LADN. |
| | If the UE is establishing a PDU session for IMS, and the UE is configured to discover the |
| | P-CSCF address during connectivity establishment, the UE shall include an indicator that it |
| | requests a P-CSCF IP address(es) within the SM container. |
| | The PS Data Off status is included in the PCO in the PDU Session Establishment Request |
| | message. |
| | If the UE requests to establish always-on PDU session, the UE includes an Always-on PDU |
| | Session Requested indication in the PDU Session Establishment Request message. |
| 2. | The AMF determines that the message corresponds to a request for a new PDU Session |
| | based on that Request Type indicates “initial request” and that the PDU Session ID is not |
| | used for any existing PDU Session(s) of the UE. If the NAS message does not contain an |
| | S-NSSAI, the AMF determines a default S-NSSAI for the requested PDU Session either |
| | according to the UE subscription, if it contains only one default S-NSSAI, or based on |
| | operator policy. When the NAS Message contains an S-NSSAI but it does not contain a |
| | DNN, the AMF determines the DNN for the requested PDU Session by selecting the |
| | default DNN for this S-NSSAI if the default DNN is present in the UE's Subscription |
| | Information; otherwise the serving AMF selects a locally configured DNN for this S- |
| | NSSAI. If the AMF cannot select an SMF (e.g. the UE provided DNN is not supported by |
| | the network, or the UE provided DNN is not in the Subscribed DNN List for the S-NSSAI |
| | and wildcard DNN is not included in the Subscribed DNN list), the AMF shall reject the |
| | NAS Message containing PDU Session Establishment Request from the UE with an |
| | appropriate cause |
| | The AMF selects an SMF as described in clause 6.3.2 of TS 23.501 [1] and |
| | clause 4.3.2.2.3. If the Request Type indicates “Initial request” or the request is due to |
| | handover from EPS or from non-3GPP access serving by a different AMF, the AMF stores |
| | an association of the S-NSSAI(s), the DNN, the PDU Session ID, the SMF ID as well as |
| | the Access Type of the PDU Session. |
| | If the Request Type is “initial request” and if the Old PDU Session ID indicating the |
| | existing PDU Session is also contained in the message, the AMF selects an SMF as |
| | described in clause 4.3.5.2 and stores an association of the new PDU Session ID, the S- |
| | NSSAI, the selected SMF ID as well as Access Type of the PDU Session. |
| | If the Request Type indicates “Existing PDU Session”, the AMF selects the SMF based on |
| | SMF-ID received from UDM. The case where the Request Type indicates “Existing PDU |
| | Session”, and either the AMF does not recognize the PDU Session ID or the subscription |
| | context that the AMF received from UDM during the Registration or Subscription Profile |
| | Update Notification procedure does not contain an SMF ID corresponding to the PDU |
| | Session ID constitutes an error case. The AMF updates the Access Type stored for the PDU |
| | Session. |
| | If the Request Type indicates “Existing PDU Session” referring to an existing PDU Session |
| | moved between 3GPP access and non-3GPP access, then if the S-NSSAI of the PDU |
| | Session is present in the Allowed NSSAI of the target access type, the PDU Session |
| | Establishment procedure can be performed in the following cases: |
| | the SMF ID corresponding to the PDU Session ID and the AMF belong to the same PLMN; |
| | the SMF ID corresponding to the PDU Session ID belongs to the HPLMN; |
| | Otherwise the AMF shall reject the PDU Session Establishment Request with an |
| | appropriate reject cause. |

NOTE 2: The SMF ID includes the PLMN ID that the SMF belongs to.

| | |
|---|---|
| | The AMF shall reject a request coming from an Emergency Registered UE and the Request |
| | Type indicates neither “Emergency Request” nor “Existing Emergency PDU Session”. |
| | When the Request Type indicates “Emergency Request”, the AMF is not expecting any S- |
| | NSSAI and DNN value provided by the UE and uses locally configured values instead. The |
| | AMF stores the Access Type of the PDU Session. |
| | If the Request Type indicates “Emergency Request” or “Existing Emergency PDU |
| | Session”, the AMF selects the SMF as described in TS 23.501 [1], clause 5.16.4. |
| 3. | From AMF to SMF: Either Nsmf_PDUSession_CreateSMContext Request (SUPI, DNN, |
| | S-NSSAI(s), PDU Session ID, AMF ID, Request Type, PCF ID, Priority Access, N1 SM |
| | container (PDU Session Establishment Request), User location information, Access Type, |
| | PEI, GPSI, UE presence in LADN service area, Subscription For PDU Session Status |
| | Notification, DNN Selection Mode, Trace Requirements) or |
| | Nsmf_PDUSession_UpdateSMContext Request (SUPI, DNN, S-NSSAI(s), PDU Session |
| | ID, AMF ID, Request Type, N1 SM container (PDU Session Establishment Request), User |
| | location information, Access Type, RAT type, PEI). |
| | If the AMF does not have an association with an SMF for the PDU Session ID provided by |
| | the UE (e.g. when Request Type indicates “initial request”), the AMF invokes the |
| | Nsmf_PDUSession_CreateSMContext Request, but if the AMF already has an association |
| | with an SMF for the PDU Session ID provided by the UE (e.g. when Request Type |
| | indicates “existing PDU Session”), the AMF invokes the |
| | Nsmf_PDUSession_UpdateSMContext Request. |
| | The AMF sends the S-NSSAI from the Allowed NSSAI to the SMF. For roaming scenario, |
| | the AMF also sends the corresponding S-NSSAI from the Mapping Of Allowed NSSAI to |
| | the SMF. |
| | The AMF ID is the UE's GUAMI which uniquely identifies the AMF serving the UE. The |
| | AMF forwards the PDU Session ID together with the N1 SM container containing the PDU |
| | Session Establishment Request received from the UE. The GPSI shall be included if |
| | available at AMF. |
| | The AMF determines Access Type and RAT Type based on the Global RAN Node ID |
| | associated with the N2 interface. |
| | The AMF provides the PEI instead of the SUPI when the UE in limited service state has |
| | registered for Emergency services (i.e. Emergency Registered) without providing a SUPI. |
| | The PEI is defined in TS 23.501 [1] clause 5.9.3. In case the UE in limited service state has |
| | registered for Emergency services (i.e. Emergency Registered) with a SUPI but has not |
| | been authenticated the AMF indicates that the SUPI has not been authenticated. The SMF |
| | determines that the UE has not been authenticated when it does not receive a SUPI for the |
| | UE or when the AMF indicates that the SUPI has not been authenticated. |
| | If the AMF determines that the DNN corresponds to an LADN then the AMF provides the |
| | “UE presence in LADN service area” that indicates if the UE is IN or OUT of the LADN |
| | service area. |
| | If the Old PDU Session ID is included in step 1, and if the SMF is not to be reallocated, the |
| | AMF also includes Old PDU Session ID in the Nsmf_PDUSession_CreateSMContext |
| | Request. |
| | DNN Selection Mode is determined by the AMF. It indicates whether an explicitly |
| | subscribed DNN has been provided by the UE in its PDU Session Establishment Request. |
| | The SMF may use DNN Selection Mode when deciding whether to accept or reject the UE |
| | request. |
| | When the Establishment cause received as part of AN parameters during the Registration |
| | procedure or Service Request procedure is associated with priority services (e.g. MPS, |
| | MCS), the AMF includes a Message Priority header to indicate priority information. The |
| | SMF uses the Message Priority header to determine if the UE request is subject to |
| | exemption from NAS level congestion control. Other NFs relay the priority information by |
| | including the Message Priority header in service-based interfaces, as specified in |
| | TS 29.500 [17]. |
| | In the local breakout case, if the SMF (in the VPLMN) is not able to process some part of |
| | the N1 SM information that Home Routed Roaming is required, and the SMF responds to |
| | the AMF that it is not the right SMF to handle the N1 SM message by invoking |
| | Nsmf_PDUSession_CreateSMContext Response service operation. The SMF includes a |
| | proper N11 cause code triggering the AMF to proceed with home routed case. The |
| | procedure starts again at step 2 of clause 4.3.2.2.2. |
| | The AMF may include a PCF ID in the Nsmf_PDUSession_CreateSMContext Request. |
| | This PCF ID identifies the H-PCF in the non-roaming case and the V-PCF in the local |
| | breakout roaming case. |
| | The AMF includes Trace Requirements if Trace Requirements have been received in |
| | subscription data. |
| 4. | If Session Management Subscription data for corresponding SUPI, DNN and S-NSSAI is |
| | not available, then SMF retrieves the Session Management Subscription data using |
| | Nudm_SDM_Get (SUPI, Session Management Subscription data, DNN, S-NSSAI) and |
| | subscribes to be notified when this subscription data is modified using |
| | Nudm_SDM_Subscribe (SUPI, Session Management Subscription data, DNN, S-NSSAI). |
| | UDM may get this information from UDR by Nudr_DM_Query (SUPI, Subscription Data, |
| | Session Management Subscription data, DNN, S-NSSAI) and may subscribe to |
| | notifications from UDR for the same data by Nudr_DM_subscribe. The S-NSSAI used |
| | with the UDM is the S-NSSAI with value for the HPLMN. |
| | The SMF may use DNN Selection Mode when deciding whether to retrieve the Session |
| | Management Subscription data e.g. in case the (DNN, S-NSSAI) is not explicitly |
| | subscribed, the SMF may use local configuration instead of Session Management |
| | Subscription data. |
| | If Request Type in step 3 indicates neither “Emergency Request” nor “Existing Emergency |
| | PDU Session” and, if the SMF has not yet registered for this PDU Session ID, then the |
| | SMF registers with the UDM using Nudm_UECM_Registration (SUPI, DNN, PDU |
| | Session ID, SMF Identity) for a given PDU Session. As a result, the UDM stores following |
| | information: SUPI, SMF identity and the associated DNN and PDU Session ID. The UDM |
| | may further store this information in UDR by Nudr_DM_Update (SUPI, Subscription Data, |
| | UE context in SMF data). |
| | If the Request Type received in step 3 indicates “Emergency Request” |
| | For an authenticated non-roaming UE, based on operator configuration (e.g. related with |
| | whether the operator uses a fixed SMF for Emergency calls, etc.), the SMF may register |
| | in the UDM using Nudm_UECM_Registration (SUPI, PDU Session ID, SMF identity, |
| | Indication of Emergency Services) for a given PDU Session that is applicable for |
| | emergency services. As a result, the UDM shall store the applicable PDU Session for |
| | Emergency services. |
| | For an unauthenticated UE or a roaming UE, the SMF shall not register in the UDM for |
| | a given PDU Session. |
| | If the Request Type in step 3 indicates “Existing PDU Session” or “Existing Emergency |
| | PDU Session” the SMF determines that the request is due to switching between 3GPP |
| | access and non-3GPP access or due to handover from EPS. The SMF identifies the existing |
| | PDU Session based on the PDU Session ID. In such a case, the SMF does not create a new |
| | SM context but instead updates the existing SM context and provides the representation of |
| | the updated SM context to the AMF in the response. |
| | If the Request Type is “Initial request” and if the Old PDU Session ID is included in |
| | Nsmf_PDUSession_CreateSMContext Request, the SMF identifies the existing PDU |
| | Session to be released based on the Old PDU Session ID. |
| | Subscription data includes the Allowed PDU Session Type(s), Allowed SSC mode(s), |
| | default 5QI and ARP, subscribed Session-AMBR. |
| | Static IP address/prefix may be included in the subscription data if the UE has subscribed to it. |
| | The SMF checks the validity of the UE request: it checks |
| | Whether the UE request is compliant with the user subscription and with local policies; |
| | (If the DNN corresponds to an LADN), whether the UE is located within the LADN |
| | service area based on the “UE presence in LADN service area” indication from the |
| | AMF. If the AMF does not provide the “UE presence in LADN service area” indication |
| | and the SMF determines that the DNN corresponds to a LADN, then the SMF considers |
| | that the UE is OUT of the LADN service area |
| | If the UE request is considered as not valid, the SMF decides to not accept to establish the |
| | PDU Session. |
| 5. | From SMF to AMF: Either Nsmf_PDUSession_CreateSMContext Response (Cause, SM |
| | Context ID or N1 SM container (PDU Session Reject (Cause))) or an |
| | Nsmf_PDUSession_UpdateSMContext Response depending on the request received in step 3. |
| | If the SMF received Nsmf_PDUSession_CreateSMContext Request in step 3 and the SMF |
| | is able to process the PDU Session establishment request, the SMF creates an SM context |
| | and responds to the AMF by providing an SM Context Identifier. |
| | In case the UP Security Policy for the PDU Session is determined to have Integrity |
| | Protection set to “Required”, the SMF may, based on local configuration, decide whether to |
| | accept or reject the PDU Session request based on the UE Integrity Protection Maximum |
| | Data Rate. |

NOTE 3: The SMF can e.g. be configured to reject a PDU Session if the UE Integrity
Protection Maximum Data Rate has a very low value, in case the services provided
by the DN would require higher bitrates.

| | |
|---|---|
| | When the SMF decides to not accept to establish a PDU Session, the SMF rejects the UE |
| | request via NAS SM signalling including a relevant SM rejection cause by responding to |
| | the AMF with Nsmf_PDUSession_CreateSMContext Response. The SMF also indicates to |
| | the AMF that the PDU Session ID is to be considered as released, the SMF proceeds to |
| | step 20 and the PDU Session Establishment procedure is stopped. |
| 6. | Optional Secondary authorization/authentication. |
| | If the Request Type in step 3 indicates “Existing PDU Session”, the SMF does not perform |
| | secondary authorization/authentication. |
| | If the Request Type received in step 3 indicates “Emergency Request” or “Existing |
| | Emergency PDU Session”, the SMF shall not perform secondary |
| | authorization/authentication. |
| | If the SMF needs to perform secondary authorization/authentication during the |
| | establishment of the PDU Session by a DN-AAA server as described in TS 23.501 [1] |
| | clause 5.6.6, the SMF triggers the PDU Session establishment authentication/authorization |
| | as described in clause 4.3.2.3. |
| 7a. | If dynamic PCC is to be used for the PDU Session, the SMF performs PCF selection as |
| | described in TS 23.501 [1], clause 6.3.7.1. If the Request Type indicates “Existing PDU |
| | Session” or “Existing Emergency PDU Session”, the SMF shall use the PCF already |
| | selected for the PDU Session. |
| | Otherwise, the SMF may apply local policy. |
| 7b. | The SMF may perform an SM Policy Association Establishment procedure as defined in |
| | clause 4.16.4 to establish an SM Policy Association with the PCF and get the default PCC |
| | Rules for the PDU Session. The GPSI shall be included if available at SMF. If the Request |
| | Type in step 3 indicates “Existing PDU Session”, the SMF may provide information on the |
| | Policy Control Request Trigger condition(s) that have been met by an SMF initiated SM |
| | Policy Association Modification procedure as defined in clause 4.16.5.1. The PCF may |
| | provide policy information defined in clause 5.2.5.4 (and in TS 23.503 [20]) to SMF. |
| | The PCF, based on the Emergency DNN, sets the ARP of the PCC rules to a value that is |
| | reserved for Emergency services as described in TS 23.503 [20]. |

NOTE 4: The purpose of step 7 is to receive PCC rules before selecting UPF. If PCC rules
are not needed as input for UPF selection, step 7 can be performed after step 8.

| | |
|---|---|
| 8. | If the Request Type in step 3 indicates “Initial request”, the SMF selects an SSC mode for |
| | the PDU Session as described in TS 23.501 [1] clause 5.6.9.3. The SMF also selects one or |
| | more UPFs as needed as described in TS 23.501 [1] clause 6.3.3. In case of PDU Session |
| | Type IPv4 or IPv6 or IPv4v6, the SMF allocates an IP address/prefix for the PDU Session |
| | as described in TS 23.501 [1] clause 5.8.1. In case of PDU Session Type IPv6 or IPv4v6, |
| | the SMF also allocates an interface identifier to the UE for the UE to build its link-local |
| | address. For Unstructured PDU Session Type the SMF may allocate an IPv6 prefix for the |
| | PDU Session and N6 point-to-point tunnelling (based on UDP/IPv6) as described in |
| | TS 23.501 [1] clause 5.6.10.3. For Ethernet PDU Session Type, neither a MAC nor an IP |
| | address is allocated by the SMF to the UE for this PDU Session. |
| | If the Request Type in Step 3 is “Existing PDU Session”, the SMF maintains the same IP |
| | address/prefix that has already been allocated to the UE in the source network. |
| | If the Request Type in step 3 indicates “Existing PDU Session” referring to an existing |
| | PDU Session moved between 3GPP access and non-3GPP access the SMF maintains the |
| | SSC mode of the PDU Session, the current PDU Session Anchor and IP address. |

NOTE 5: The SMF may decide to trigger e.g. new intermediate UPF insertion or allocation
of a new UPF as described in step 5 in clause 4.2.3.2.

| | |
|---|---|
| | If the Request Type indicates “Emergency Request”, the SMF selects the UPF as described |
| | in TS 23.501 [1] clause 5.16.4 and selects SSC mode 1. |
| 9. | SMF may perform an SMF initiated SM Policy Association Modification procedure as |
| | defined in clause 4.16.5.1 to provide information on the Policy Control Request Trigger |
| | condition(s) that have been met. If Request Type is “initial request” and dynamic PCC is |
| | deployed and PDU Session Type is IPv4 or IPv6 or IPv4v6, SMF notifies the PCF (if the |
| | Policy Control Request Trigger condition is met) with the allocated UE IP |
| | address/prefix(es). |
| | When PCF is deployed, the SMF shall further report the PS Data Off status to PCF if the |
| | PS Data Off Policy Control Request Trigger is provisioned, the additional behaviour of |
| | SMF and PCF for 3GPP PS Data Off is defined in TS 23.503 [20]. |

NOTE 6: If an IP address/prefix has been allocated before step 7 (e.g. subscribed static IP
address/prefix in UDM/UDR) or the step 7 is perform after step 8, the IP
address/prefix can be provided to PCF in step 7, and the IP address/prefix notification
in this step can be skipped.

| | |
|---|---|
| | PCF may provide updated policies to the SMF. The PCF may provide policy information |
| | defined in clause 5.2.5.4 (and in TS 23.503 [20]) to SMF. |
| 10. | If Request Type indicates “initial request”, the SMF initiates an N4 Session Establishment |
| | procedure with the selected UPF, otherwise it initiates an N4 Session Modification |
| | procedure with the selected UPF: |
| 10a. | The SMF sends an N4 Session Establishment/Modification Request to the UPF |
| | and provides Packet detection, enforcement and reporting rules to be installed on the |
| | UPF for this PDU Session. If CN Tunnel Info is allocated by the SMF, the CN Tunnel |
| | Info is provided to UPF in this step. If the selective User Plane deactivation is required |
| | for this PDU Session, the SMF determines the Inactivity Timer and provides it to the |
| | UPF. The SMF provides Trace Requirements to the UPF if it has received Trace |
| | Requirements. |
| 10b. | The UPF acknowledges by sending an N4 Session Establishment/Modification |
| | Response. If CN Tunnel Info is allocated by the UPF, the CN Tunnel Info is provided to |
| | SMF in this step. |
| | If multiple UPFs are selected for the PDU Session, the SMF initiate N4 Session |
| | Establishment/Modification procedure with each UPF of the PDU Session in this step. |
| | If the Request Type indicates “Existing PDU Session”, and the SMF creates CN Tunnel |
| | Info, then this step is skipped. Otherwise, this step is performed to obtain the CN Tunnel |
| | Info from the UPF using the N4 Session Modification Procedure. |
| 11. | SMF to AMF: Namf_Communication_N1N2MessageTransfer (PDU Session ID, N2 SM |
| | information (PDU Session ID, QFI(s), QoS Profile(s), CN Tunnel Info, S-NSSAI from the |
| | Allowed NSSAI, Session-AMBR, PDU Session Type, User Plane Security Enforcement |
| | information, UE Integrity Protection Maximum Data Rate), N1 SM container (PDU |
| | Session Establishment Accept (QoS Rule(s) and QoS Flow level QoS parameters if needed |
| | for the QoS Flow(s) associated with the QoS rule(s), selected SSC mode, S-NSSAI(s), |
| | DNN, allocated IPv4 address, interface identifier, Session-AMBR, selected PDU Session |
| | Type, Reflective QoS Timer (if available), P-CSCF address(es), [Always-on PDU |
| | Session]))). If multiple UPFs are used for the PDU Session, the CN Tunnel Info contain |
| | tunnel information related with the UPF that terminates N3. |
| | The N2 SM information carries information that the AMF shall forward to the RAN which |
| | includes: |
| | The CN Tunnel Info corresponds to the Core Network address of the N3 tunnel |
| | corresponding to the PDU Session. |
| | One or multiple QoS profiles and the corresponding QFIs can be provided to the RAN. |
| | This is further described in TS 23.501 [1] clause 5.7. |
| | The PDU Session ID may be used by AN signalling with the UE to indicate to the UE |
| | the association between RAN resources and a PDU Session for the UE. |
| | A PDU Session is associated to an S-NSSAI and a DNN. The S-NSSAI provided to the |
| | RAN, is the S-NSSAI with the value for the serving PLMN. |
| | User Plane Security Enforcement information is determined by the SMF as described in |
| | clause 5.10.3 of TS 23.501 [1], |
| | If the User Plane Security Enforcement information indicates that Integrity Protection is |
| | “Preferred” or “Required”, the SMF also includes the UE Integrity Protection Maximum |
| | Data Rate as received in the 5GSM Capability. |
| | The N1 SM container contains the PDU Session Establishment Accept that the AMF shall |
| | provide to the UE. If the UE requested P-CSCF discovery then the message shall also |
| | include the P-CSCF IP address(es) as determined by the SMF. The PDU Session |
| | Establishment Accept includes S-NSSAI from the Allowed NSSAI. For roaming scenario, |
| | the PDU Session Establishment Accept also includes corresponding S-NSSAI from the |
| | Mapping Of Allowed NSSAI that SMF received in step 3. If the PDU Session being |
| | established was requested to be an always-on PDU Session, the SMF shall indicate whether |
| | the request is accepted by including an Always-on PDU Ssession Granted indication in the |
| | PDU Session Establishment Accept message. If the PDU Session being established was not |
| | requested to be an always-on PDU Session but the SMF determines that the PDU Session |
| | needs to be established as an always-on PDU Session, the SMF shall include an Always-on |
| | PDU Session Granted indication in the PDU Session Establishment Accept message |
| | indicating that the PDU session is an always-on PDU Session. |
| | Multiple QoS Rules, QoS Flow level QoS parameters if needed for the QoS Flow(s) |
| | associated with those QoS rule(s) and QoS Profiles may be included in the PDU Session |
| | Establishment Accept within the N1 SM and in the N2 SM information. |
| | The Namf_Communication_N1N2MessageTransfer contains the PDU Session ID allowing |
| | the AMF to know which access towards the UE to use. |
| 12. | AMF to RAN: N2 PDU Session Request (N2 SM information, NAS message (PDU |
| | Session ID, N1 SM container (PDU Session Establishment Accept))). |
| | The AMF sends the NAS message containing PDU Session ID and PDU Session |
| | Establishment Accept targeted to the UE and the N2 SM information received from the |
| | SMF within the N2 PDU Session Request to the RAN. |
| 13. | RAN to UE: The RAN may issue AN specific signalling exchange with the UE that is |
| | related with the information received from SMF. For example, in case of a NG-RAN, an |
| | RRC Connection Reconfiguration may take place with the UE establishing the necessary |
| | NG-RAN resources related to the QoS Rules for the PDU Session request received in step 12. |
| | RAN also allocates RAN N3 tTunnel Info for the PDU Session. In case of Dual |
| | Connectivity, the Master RAN node may assign some (zero or more) QFIs to be setup to a |
| | Master RAN node and others to the Secondary RAN node. The AN Tunnel Info includes a |
| | tunnel endpoint for each involved RAN node, and the QFIs assigned to each tunnel |
| | endpoint. A QFI can be assigned to either the Master RAN node or the Secondary RAN |
| | node and not to both. |
| | RAN forwards the NAS message (PDU Session ID, N1 SM container (PDU Session |
| | Establishment Accept)) provided in step 12 to the UE. RAN shall only provide the NAS |
| | message to the UE if the necessary RAN resources are established and the allocation of |
| | RAN Tunnel Info are successful. |
| | If MICO mode is active and the NAS message Request Type in step 1 indicated |
| | “Emergency Request”, then the UE and the AMF shall locally deactivate MICO mode. |
| 14. | RAN to AMF: N2 PDU Session Response (PDU Session ID, Cause, N2 SM information |
| | (PDU Session ID, AN Tunnel Info, List of accepted/rejected QFI(s), User Plane |
| | Enforcement Policy Notification)). |
| | The AN Tunnel Info corresponds to the Access Network address of the N3 tunnel |
| | corresponding to the PDU Session. |
| | If the RAN rejects QFI(s) the SMF is responsible of updating the QoS rules and QoS Flow |
| | level QoS parameters if needed for the QoS Flow associated with the QoS rule(s) in the UE |
| | accordingly. |
| | The NG-RAN rejects the establishment of UP resources for the PDU Session when it |
| | cannot fulfill User Plane Security Enforcement information with a value of Required. In |
| | this case the SMF releases the PDU session. The NG-RAN notifies the SMF when it cannot |
| | fulfill a User Plane Security Enforcement with a value of Preferred. |
| 15. | AMF to SMF: Nsmf_PDUSession_UpdateSMContext Request (N2 SM information, |
| | Request Type). |
| | The AMF forwards the N2 SM information received from RAN to the SMF. |
| | If the list of rejected QFI(s) is included in N2 SM information, the SMF shall release the |
| | rejected QFI(s) associated QoS profiles. |
| | If the User Plane Enforcement Policy Notification in the N2 SM information indicates that |
| | no user plane resources could be established, and the User Plane Enforcement Policy |
| | indicated “required” as described in clause 5.10.3 of TS 23.501 [1], the SMF shall release |
| | the PDU session. |
| 16a. | The SMF initiates an N4 Session Modification procedure with the UPF. The SMF |
| | provides AN Tunnel Info to the UPF as well as the corresponding forwarding rules. |

NOTE 7: If the PDU Session Establishment Request was due to mobility between 3GPP and
non-3GPP access or mobility from EPC, the downlink data path is switched towards
the target access in this step.

| | |
|---|---|
| 16b. | The UPF provides an N4 Session Modification Response to the SMF. |
| | If multiple UPFs are used in the PDU Session, the UPF in step 16 refers to the UPF |
| | terminating N3. |
| | After this step, the UPF delivers any down-link packets to the UE that may have been |
| | buffered for this PDU Session. |
| 17. | SMF to AMF: Nsmf_PDUSession_UpdateSMContext Response (Cause). |
| | The SMF may subscribe to the UE mobility event notification from the AMF (e.g. location |
| | reporting, UE moving into or out of Area Of Interest), after this step by invoking |
| | Namf_EventExposure_Subscribe service operation as specified in clause 5.2.2.3.2. For |
| | LADN, the SMF subscribes to the UE moving into or out of LADN service area event |
| | notification by providing the LADN DNN as an indicator for the Area Of Interest (see |
| | clause 5.6.5 and 5.6.11 of TS 23.501 [1]). |
| | After this step, the AMF forwards relevant events subscribed by the SMF. |
| 18. | [Conditional] SMF to AMF: Nsmf_PDUSession_SMContextStatusNotify (Release) |
| | If during the procedure, any time after step 5, the PDU Session establishment is not |
| | successful, the SMF informs the AMF by invoking |
| | Nsmf_PDUSession_SMContextStatusNotify (Release). The SMF also releases any N4 |
| | session(s) created, any PDU Session address if allocated (e.g IP address) and releases the |
| | association with PCF, if any. |
| 19. | SMF to UE, via UPF: In case of PDU Session Type IPv6 or IPv4v6, the SMF generates |
| | an IPv6 Router Advertisement and sends it to the UE via N4 and the UPF. |
| 20. | If the PDU Session establishment failed after step 4, the SMF shall perform the |
| | following: |
| a) | The SMF unsubscribes to the modifications of Session Management Subscription data |
| | for the corresponding (SUPI, DNN, S-NSSAI), using Nudm_SDM_Unsubscribe (SUPI, |
| | Session Management Subscription data, DNN, S-NSSAI), if the SMF is no more |
| | handling a PDU Session of the UE for this (DNN, S-NSSAI). The UDM may |
| | unsubscribe to the modification notification from UDR by Nudr_DM_Unsubscribe |
| | (SUPI, Subscription Data, Session Management Subscription data, S-NSSAI, DNN). |
| b) | The SMF deregisters for the given PDU Session using Nudm_UECM_Deregistration |
| | (SUPI, DNN, PDU Session ID). The UDM may update corresponding UE context by |
| | Nudr_DM_Update (SUPI, Subscription Data, UE context in SMF data). |

The 3GPP Specification Group on Service and Systems Aspects, Architecture Subgroup (SA2) agreed in document S2-1901089 that the operations in step 13 above provide that the DL NAS transport carrying the PDU session establishment accept message is not sent by the 5G access network to the UE if the 5G access network cannot allocate radio resources needed for the PDU session. Consequently, if the DL NAS transport carrying the PDU session establishment accept message is not sent to the UE, according to TS 24.501 subclause 6.4.1.6 bullet (a), upon expiration of timer T3580, the UE will retransmit a PDU session establishment request message and transport it using an UL NAS transport to the AMF. Subsequently, according to TS 24.501 subclause 5.4.5.2.5 bullet (a)(12), upon reception of the UL NAS transport with the retransmitted PDU session establishment request message from the UE, the AMF performs a local release of the existing PDU session and requests the SMF perform a local release of the existing PDU session, after which the AMF performs a new SMF selection and forwards the retransmitted PDU session establishment request message to a new SMF. If the new SMF attempts to set up the PDU session with resources which the 5G access network is again unable to allocate, and the 5G access network does not send the DL NAS transport carrying the PDU session establishment accept message to the UE again, the process described in the above paragraph will repeat five (5) times.

However, there currently exist certain challenge(s). As noted above, if the 5G access network does not send the DL NAS transport carrying PDU session establishment accept message to the UE, the process described above will repeat five (5) times, which may generate an excessive number of unnecessary 5G session management (SM) messages sent over the radio and may further result in unnecessary network actions (e.g., the AMF will select an SMF, the SMF will attempt to establish a PDU session, the AMF and the SMF will locally release the PDU session, and so forth, all repeated up to five (5) times).

### SUMMARY

Systems and methods for avoiding transmission of unnecessary 5G session management (SM) messages are disclosed herein. Embodiments of a method performed in a core network of a cellular communications system to avoid transmission of unnecessary SM messages are disclosed. In some embodiments, the method comprises, at a radio access network (RAN), determining that a non-access stratum (NAS) message carrying a Protocol Data Unit (PDU) session establishment accept indication was not sent to a user equipment (UE). The method further comprises sending, to an Access and Mobility Management Function (AMF), an N2 PDU session request acknowledgment indication comprising a cause indicating that the NAS message carrying the PDU session establishment accept indication was not sent to the UE. The method also comprises, at the AMF, receiving, from the RAN, the N2 PDU session request acknowledgment indication comprising the cause. The method additionally comprises sending an Nsmf_PDUSession_UpdateSMContext request comprising the cause to a Session Management Function (SME). The method further comprises, at the SMF, determining that the NAS message carrying the PDU session establishment accept indication was not sent to the UE by the RAN. The method also comprises, responsive to determining that the NAS message carrying the PDU session establishment accept indication was not sent to the UE, sending a PDU session establishment reject indication to the UE.

Embodiments of a method performed by an SMF in a core network of a cellular communications system to avoid transmission of unnecessary SM messages are disclosed. In some embodiments, the method comprises determining that an NAS message carrying a PDU session establishment accept indication was not sent to a UE by a RAN. The method further comprises, responsive to determining that the NAS message carrying the PDU session establishment accept indication was not sent to the UE, sending a PDU session establishment reject indication to the UE. In some embodiments, determining that the NAS message carrying the PDU session establishment accept indication was not sent to the UE comprises receiving, from an AMF, an Nsmf_PDUSession_UpdateSMContext request comprising a cause, and determining that the NAS message carrying the PDU session establishment accept indication was not sent to the UE based on the cause. In some embodiments, sending the PDU session establishment reject indication to the UE comprises sending an Namf_Communication_N1N2MessageTransfer comprising the PDU session establishment reject indication to the AMF.

Embodiments of an SMF for a core network of a cellular communications system enabled to avoid transmission of unnecessary SM messages are disclosed. In some embodiments, the SMF is adapted to determine that an NAS message carrying a PDU session establishment accept indication was not sent to a UE by a radio access network. The SMF is further adapted to send a PDU session establishment reject indication to the UE responsive to determining that the NAS message carrying the PDU session establishment accept indication was not sent to the UE. In some embodiments, the SMF is further adapted to perform any of the steps attributed to the SMF in any of the above-disclosed methods.

Embodiments of a network node for implementing an SMF for a core network of a cellular communications system, where the SMF is enabled to avoid transmission of unnecessary SM messages, are disclosed. In some embodiments, the network node comprises a network interface, and processing circuitry associated with the network interface. The processing circuitry is adapted to cause the network node to implement the SMF such that the SMF is configured to determine that an NAS message carrying a PDU session establishment accept indication was not sent to a UE by a radio access network. The processing circuitry is further adapted to cause the network node to implement the SMF such that the SMF is further configured to send a PDU session establishment reject indication to the UE, responsive to determining that the NAS message carrying the PDU session establishment accept indication was not sent to the UE. In some embodiments, the processing circuitry is adapted to cause the network node to implement the SMF such that the SMF is further configured to perform any of the steps attributed to the SMF in any of the above-disclosed methods.

Embodiments of a method performed by a RAN in a core network of a cellular communications system to avoid transmission of unnecessary SM messages are disclosed. In some embodiments, the method comprises determining that an NAS message carrying a PDU session establishment accept indication was not sent to a UE. The method further comprises sending, to an AMF, an N2 PDU session request acknowledgment indication comprising a cause indicating that the NAS message carrying the PDU session establishment accept indication was not sent to the UE. In some embodiments, the method also comprises receiving a PDU session establishment reject indication from the AMF. The method additionally comprises sending the PDU session establishment reject indication to the UE using access network signaling.

Embodiments of a RAN for a core network of a cellular communications system enabled to avoid transmission of unnecessary SM messages are disclosed. In some embodiments, the RAN is adapted to determine that an NAS message carrying a PDU session establishment accept indication was not sent to a UE. The RAN is further adapted to send, to an AMF, an N2 PDU session request acknowledgment indication comprising a cause indicating that the NAS message carrying the PDU session establishment accept indication was not sent to the UE. In some embodiments, the RAN is further adapted to perform any of the steps attributed to the RAN in any of the above-disclosed methods.

Embodiments of a network node for implementing a RAN for a core network of a cellular communications system where the RAN is enabled to avoid transmission of unnecessary SM messages are disclosed. In some embodiments, the network node comprises a network interface, and processing circuitry associated with the network interface. The processing circuitry is adapted to cause the network node to implement the RAN such that the RAN is configured to determine that an NAS message carrying a PDU session establishment accept indication was not sent to a UE. The processing circuitry is further adapted to cause the network node to implement the RAN such that the RAN is further configured to send, to an AMF, an N2 PDU session request acknowledgment indication comprising a cause indicating that the NAS message carrying the PDU session establishment accept indication was not sent to the UE. In some embodiments, the processing circuitry is further adapted to cause the network node to implement the RAN such that the RAN is further configured to perform any of the steps attributed to the RAN in any of the above-disclosed methods.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIGS. 1 and 1B are a reproduction of FIG. 4.3.2.2.1-1 excerpted from Third Generation Partnership Project (3GPP) Technical Specification (TS) 23.502 that illustrates operations for user equipment (UE)-requested Protocol Data Unit (PDU) session establishment for non-roaming and roaming with local breakout;

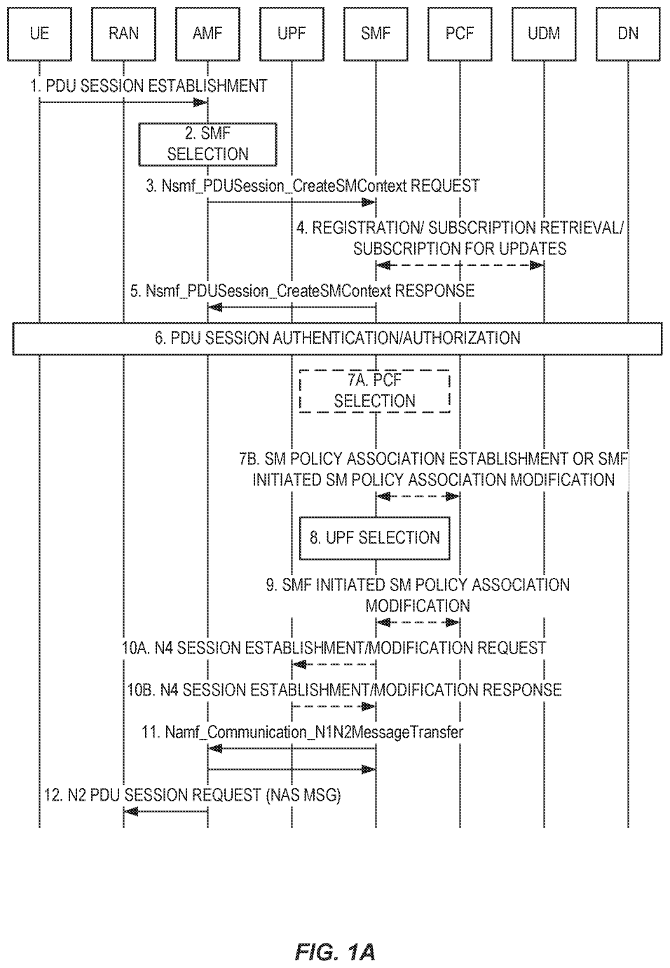

FIG. 2 illustrates one example of a cellular communications system according to some embodiments of the present disclosure;

FIG. 3 illustrates a wireless communication system represented as a 5G network architecture composed of core Network Functions (NFs), where interaction between any two NFs is represented by a point-to-point reference point/interface;

FIG. 4 illustrates a 5G network architecture using service-based interfaces between the NFs in the control plane, instead of the point-to-point reference points/interfaces used in the 5G network architecture of FIG. 3;

FIGS. 5A and 5B illustrate signaling flows among elements of a cellular communications system for avoiding transmission of unnecessary 5G session management (SM) (5GSM) messages according to embodiments disclosed herein;

FIG. 6 is a schematic block diagram of a network node according to some embodiments of the present disclosure;

FIG. 7 is a schematic block diagram that illustrates a virtualized embodiment of the network node of FIG. 6 according to some embodiments of the present disclosure;

FIG. 8 is a schematic block diagram of the network node of FIG. 6 according to some other embodiments of the present disclosure;

FIG. 9 is a schematic block diagram of a UE according to some embodiments of the present disclosure; and

FIG. 10 is a schematic block diagram of the UE of FIG. 9 according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless device.

Radio Access Node: As used herein, a “radio access node” or “radio network node” is any node in a radio access network of a cellular communications system that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pica base station, a home eNB, or the like), and a relay node.

Core Network Entity: As used herein, a “core network entity” is any type of entity in a core network. Some examples of a core network entity include, e.g., a Mobility Management Entity (MME), a Packet Data Network Gateway (P-GW), a Service Capability Exposure Function (SCEF), or the like in an Evolved Packet Core (EPC). Some other examples of a core network entity include, e.g., an Access and Mobility Management Function (AMF), a Network Slice Selection Function (NSSF), an Authentication Server Function (AUSF), a UDM, a Session Management Function (SMF), a Policy Control Function (PCF), an AF, a NEF, a User Plane Function (UPF), or the like in a 5G Core (5GC). A core network entity may be implemented as a physical network node (e.g., including hardware or a combination of hardware and software) or implemented as a functional entity (e.g., as software) that is, e.g., implemented on a physical network node or distributed across two or more physical network nodes.

Wireless Device: As used herein, a “wireless device” is any type of device that has access to (i.e., is served by) a cellular communications system by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Systems and methods for avoiding transmission of unnecessary 5GSM messages are disclosed herein.

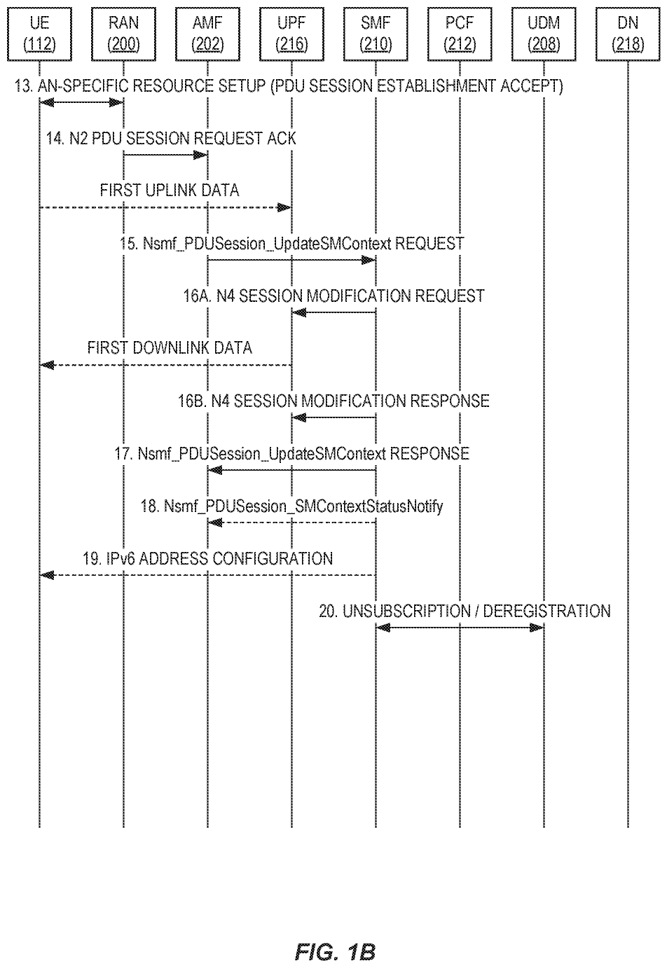

In this regard, FIG. 2 illustrates one example of a cellular communications system 200 in which embodiments of the present disclosure may be implemented. In the embodiments described herein, the cellular communications system 200 is a 5G System (5GS) including a 5G radio access network (e.g., a NR radio access network) and a 5G Core (5GC); however, the present disclosure is not limited thereto. In this example, the cellular communications system 200 includes base stations 202-1 and 202-2, which in 5G NR are referred to as gNBs, controlling corresponding macro cells 204-1 and 204-2. The base stations 202-1 and 202-2 are generally referred to herein collectively as base stations 202 and individually as base station 202. Likewise, the macro cells 204-1 and 204-2 are generally referred to herein collectively as macro cells 204 and individually as macro cell 204. The cellular communications system 200 may also include a number of low power nodes 206-1 through 206-4 controlling corresponding small cells 208-1 through 208-4. The low power nodes 206-1 through 206-4 can be small base stations (such as pico or femto base stations) or Remote Radio Heads (RRHs), or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The base stations 202 (and optionally the low power nodes 206) are connected to a core network 210. For a 5GS, the core network 210 is a 5GC.

The base stations 202 and the low power nodes 206 provide service to wireless devices 212-1 through 212-5 in the corresponding cells 204 and 208. The wireless devices 212-1 through 212-5 are generally referred to herein collectively as wireless devices 212 and individually as wireless device 212. The wireless devices 212 are also sometimes referred to herein as UEs.

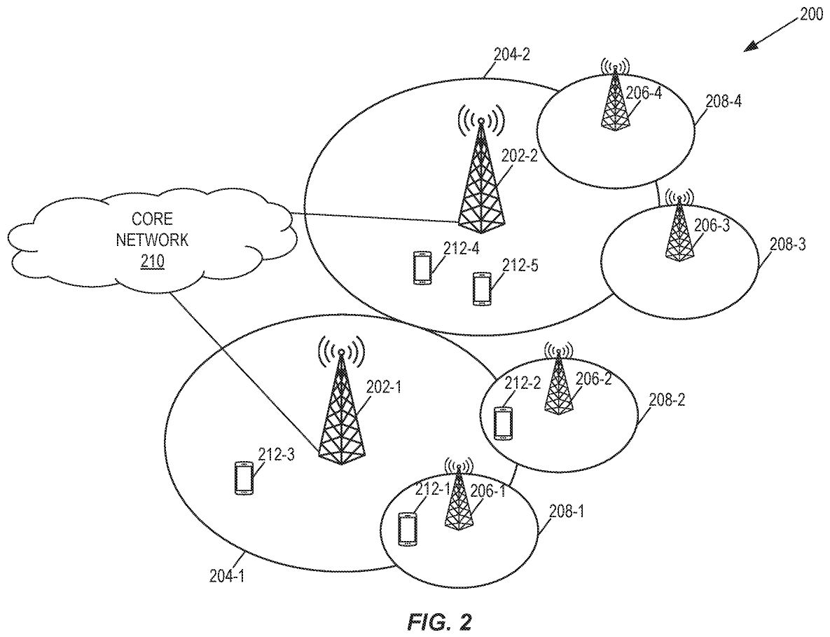

FIG. 3 illustrates one particular implementation of the cellular communications system 200 of FIG. 2, in which the cellular communications system 200 is represented as a 5G network architecture composed of core Network Functions (NFs), where interaction between any two NFs is represented by a point-to-point reference point/interface. Seen from the access side, the 5G network architecture shown in FIG. 3 comprises a plurality of UEs 212 connected to either a Radio Access Network (RAN) 300 or an Access Network (AN) (not shown) as well as an AMF 302. Typically, the RAN 300 comprises base stations, e.g., such as eNBs or gNBs or similar. Seen from the core network side, the 5G core NFs shown in FIG. 3 include an NSSF 304, an AUSF 306, a UDM 308, the AMF 302, an SMF 310, a PCF 312, and an AF 314.

Reference point representations of the 5G network architecture are used to develop detailed call flows in the normative standardization. The N1 reference point is defined to carry signaling between the UE 212 and AMF 302. The reference points for connecting between the RAN 300 and the AMF 302 and between the RAN 300 and the UPF 316 are defined as N2 and N3, respectively. There is a reference point, N11, between the AMF 302 and the SMF 310, which implies that the SMF 310 is at least partly controlled by the AMF 302. N4 is used by the SMF 310 and the UPF 316 so that the UPF 316 can be set using the control signal generated by the SMF 310, and the UPF 316 can report its state to the SMF 310. N9 is the reference point for the connection between different UPFs 316, and N14 is the reference point connecting between different AMFs 302, respectively. N15 and N7 are defined since the PCF 312 applies policy to the AMF 302 and the SMF 310, respectively. N12 is required for the AMF 302 to perform authentication of the UE 212. N8 and N10 are defined because the subscription data of the UE 212 is required for the AMF 302 and the SMF 310.

The 5G core network aims at separating user plane and control plane. The user plane carries user traffic while the control plane carries signaling in the network. In FIG. 3, the UPF 316 is in the user plane and all other NFs, i.e., the AMF 302, the SMF 310, the PCF 312, the AF 314 the AUSF 306, and the UDM 308, are in the control plane. Separating the user plane and control plane guarantees each plane resources to be scaled independently. It also allows the UPFs 316 to be deployed separately from control plane functions in a distributed fashion. In this architecture, the UPFs 316 may be deployed very close to the UEs 212 to shorten the Round Trip Time (RTT) between the UEs 212 and the data network for some applications requiring low latency.

The core 5G network architecture is composed of modularized functions. For example, the AMF 302 and the SMF 310 are independent functions in the control plane. Separated AMFs 302 and SMFs 310 allow independent evolution and scaling. Other control plane functions like the PCF 312 and the AUSF 306 can be separated as shown in FIG. 3. Modularized function design enables the 5G core network to support various services flexibly.

Each NF interacts with another NF directly. It is possible to use intermediate functions to route messages from one NF to another NF. In the control plane, a set of interactions between two NFs is defined as service so that its reuse is possible. This service enables support for modularity. The user plane supports interactions such as forwarding operations between different UPFs 316.

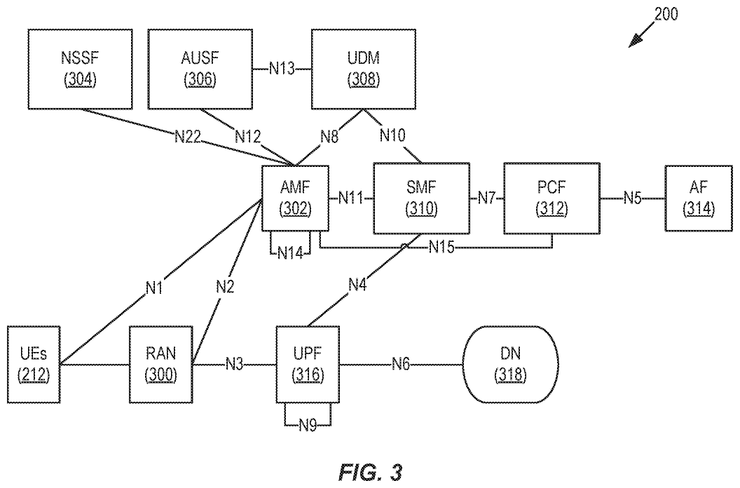

FIG. 4 illustrates a 5G network architecture using service-based interfaces between the NFs in the control plane, instead of the point-to-point reference points/interfaces used in the 5G network architecture of FIG. 3. However, the NFs described above with reference to FIG. 3 correspond to the NFs shown in FIG. 4. The service(s), etc. that an NF provides to other authorized NFs can be exposed to the authorized NFs through the service-based interface. In FIG. 4, the service based interfaces are indicated by the letter “N” followed by the name of the NF, e.g. Namf for the service based interface of the AMF 302, and Nsmf for the service based interface of the SMF 310, etc. An NEF 400 and a Network Repository Function (NRF) 402 in FIG. 4 are not shown in FIG. 3 discussed above. However, it should be clarified that all NFs depicted in FIG. 3 can interact with the NEF 400 and the NRF 402 of FIG. 4 as necessary, though not explicitly indicated in FIG. 3.

Some properties of the NFs shown in FIGS. 3 and 4 may be described in the following manner. The AMF 302 provides UE-based authentication, authorization, mobility management, etc. A UE of the UE(s) 212, even using multiple access technologies, is basically connected to a single AMF 302 because the AMF 302 is independent of the access technologies. The SMF 310 is responsible for session management and allocates IP addresses to the UEs 212. It also selects and controls the UPF 316 for data transfer. If a UE 212 has multiple sessions, different SMFs 310 may be allocated to each session to manage them individually and possibly provide different functionalities per session. The AF 314 provides information on the packet flow to the PCF 312 responsible for policy control in order to support Quality of Service (QoS). Based on the information, the PCF 312 determines policies about mobility and session management to make the AMF 302 and the SMF 310 operate properly. The AUSF 306 supports authentication functions for UEs 212 or similar and thus stores data for authentication of UEs 212 or similar while the UDM 308 stores subscription data of the UEs 212. The Data Network (DN) 318, not part of the 5G core network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

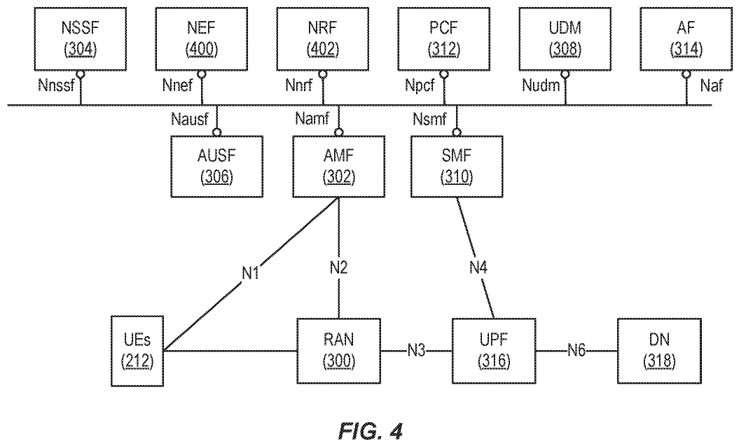

The steps of FIGS. 5A and 5B are based on the baseline procedure, described in detail above, that was excerpted from TS 23.502, subclause 4.3.2.2.1. The operations 500-526 shown in FIG. 5A correspond to the operations numbered 1-12 in the baseline procedure excerpted from TS 23.502, and are not reproduced here for the sake of brevity. In FIG. 5B, the operations shown represent operations for avoiding transmission of unnecessary 5GSM messages according to embodiments disclosed herein. Thus, in FIG. 5B, at step 528, the RAN 300 determines that an NAS carrying a PDU session establishment accept indication was not sent to the UE 212, and sends to the AMF 302 an N2 PDU Session Request Acknowledgement that includes a PDU Session ID, a Cause, and N2 SM information (e.g., PDU Session ID, AN Tunnel Info, List of accepted/rejected QFI(s), and User Plane Enforcement Policy Notification). At step 530, the AMF 302 sends a Nsmf_PDUSession_UpdateSMContext Request comprising N2 SM information and Request Type to the SMF 310.

At step 532, the SMF 310 determines (e.g., based on the Cause provided by the AMF at step 15) that the NAS message carrying the PDU session establishment accept message was not sent to the UE 212 by the 5G access network, and consequently initiates the release of the PDU session. The SMF 310 at step 534 sends a Nsmf_PDUSession_UpdateSMContext response to the AMF 302. Subsequently, at step 536, the SMF 310 determines that the NAS message carrying the PDU session establishment accept indication was not sent to the UE 212, and sends a PDU session establishment reject message using a Namf_Communication_N1N2MessageTransfer to the AMF 302. In some embodiments, the PDU session establishment reject message includes the 5GSM cause value #26 “insufficient resources,” the 5GSM cause value #69 “insufficient resources for specific slice,” or the 5GSM cause value #67 “insufficient resources for specific slice and DNN” as the 5GSM cause. The AMF 302 then sends the PDU session establishment reject message via an N2 downlink NAS transport request to the RAN 300 at step 538, which then uses access network signaling to send the PDU session establishment reject message to the UE 212 at step 540. The UE 212 then releases the PDU session at step 542.

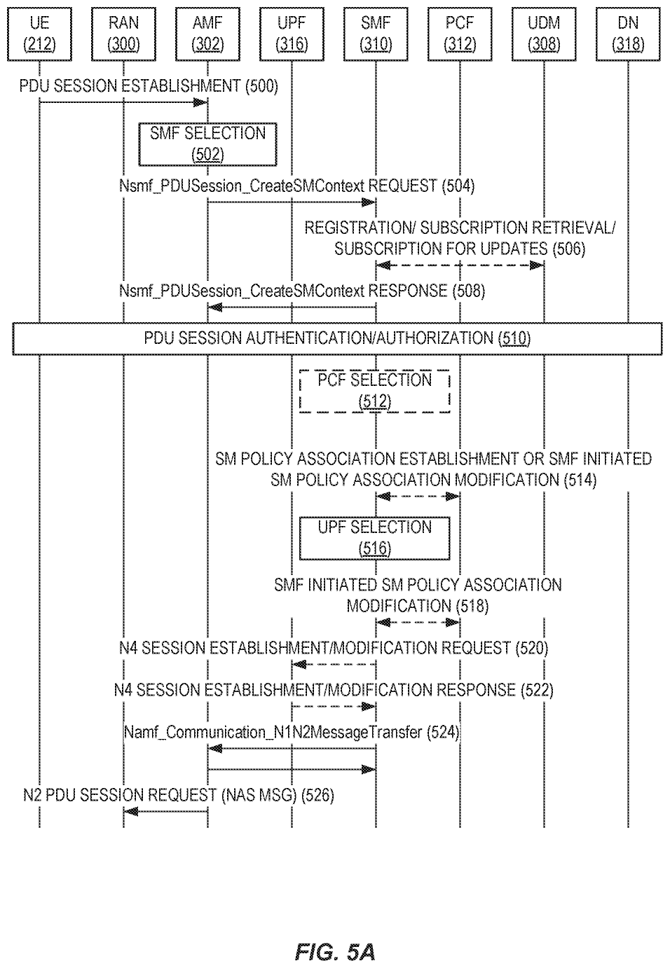

FIG. 6 is a schematic block diagram of a network node 600 according to some embodiments of the present disclosure. The network node 600 may be, for example, a core network node or a network node implementing a core network entity (e.g., an SMF, UPF, NEF, or the like). As illustrated, the network node 600 includes one or more processors 604 (e.g., Central Processing Units (CPUs), Application Specific Integrated Circuits (ASICs), Field Programmable Gate Arrays (FPGAs), and/or the like), memory 606, and a network interface 608. The one or more processors 604 are also referred to herein as processing circuitry. The one or more processors 604 operate to cause the network node 600 to provide one or more functions of a core network entity (e.g., an AMF, V-SMF, V-UPF, H-SMF, H-UPF, UDM, or NEF) as described herein. In some embodiments, the function(s) are implemented in software that is stored, e.g., in the memory 606 and executed by the one or more processors 604.

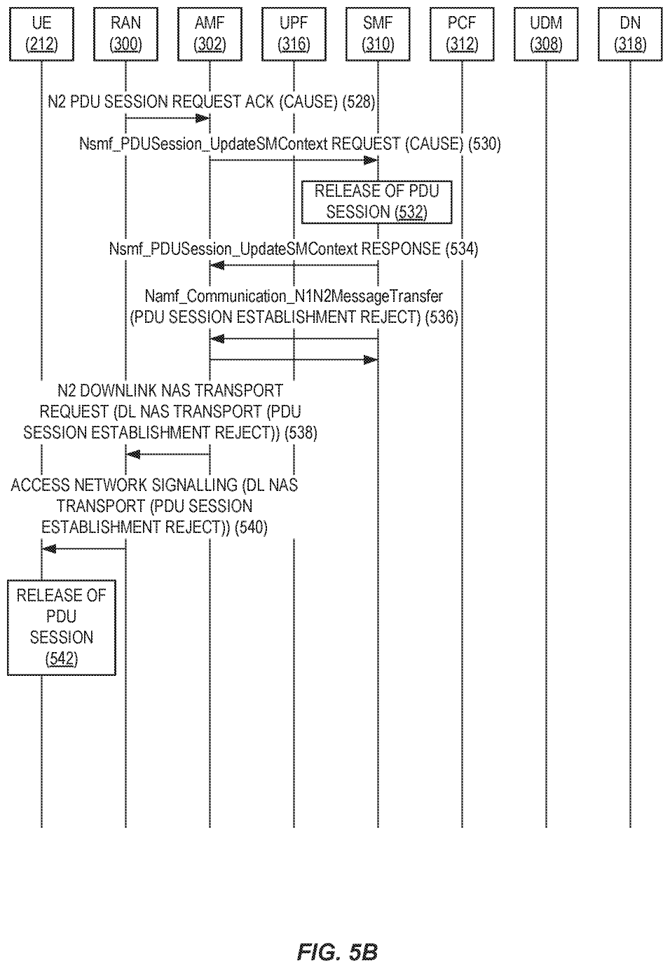

FIG. 7 is a schematic block diagram that illustrates a virtualized embodiment of the network node 600 according to some embodiments of the present disclosure. This discussion is equally applicable to other types of network nodes. Further, other types of network nodes may have similar virtualized architectures.

As used herein, a “virtualized” network node is an implementation of the network node 600 in which at least a portion of the functionality of the network node 600 is implemented as a virtual component(s) (e.g., via a virtual machine(s) executing on a physical processing node(s) in a network(s)). As illustrated, in this example, the network node 600 includes one or more processing nodes 700 coupled to or included as part of a network(s) 702. Each processing node 700 includes one or more processors 704 (e.g., CPUs, ASICs, FPGAs, and/or the like), memory 706, and a network interface 708.

In this example, function(s) 710 of the network node 600 described herein (e.g., the function(s) of a core network entity such as, e.g., an AMF, V-SMF, V-UPF, H-SMF, H-UPF, UDM, or NEF) are implemented at the one or more processing nodes 700 in any desired manner. In some particular embodiments, some or all of the function(s) 710 of the network node 600 described herein are implemented as virtual components executed by one or more virtual machines implemented in a virtual environment(s) hosted by the processing node(s) 700.

In some embodiments, a computer program including instructions which, when executed by at least one processor, causes the at least one processor to carry out the functionality of a core network entity (e.g., an AMF, V-SMF, V-UPF, H-SMF, H-UPF, UDM, or NEF) as described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

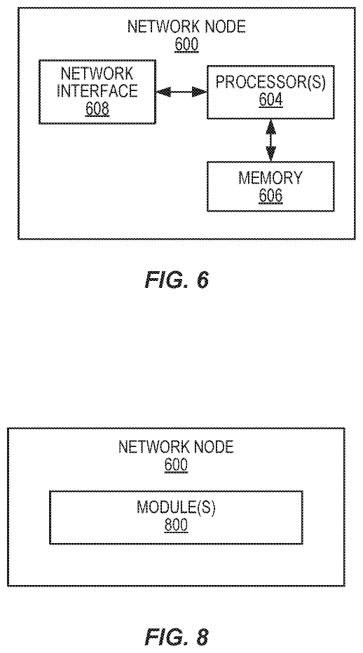

FIG. 8 is a schematic block diagram of the network node 600 according to some other embodiments of the present disclosure. The network node 600 includes one or more modules 800, each of which is implemented in software. The module(s) 800 provide the functionality of a core network entity (e.g., an AMF, V-SMF, V-UPF, H-SMF, H-UPF, UDM, or NEF) as described herein.

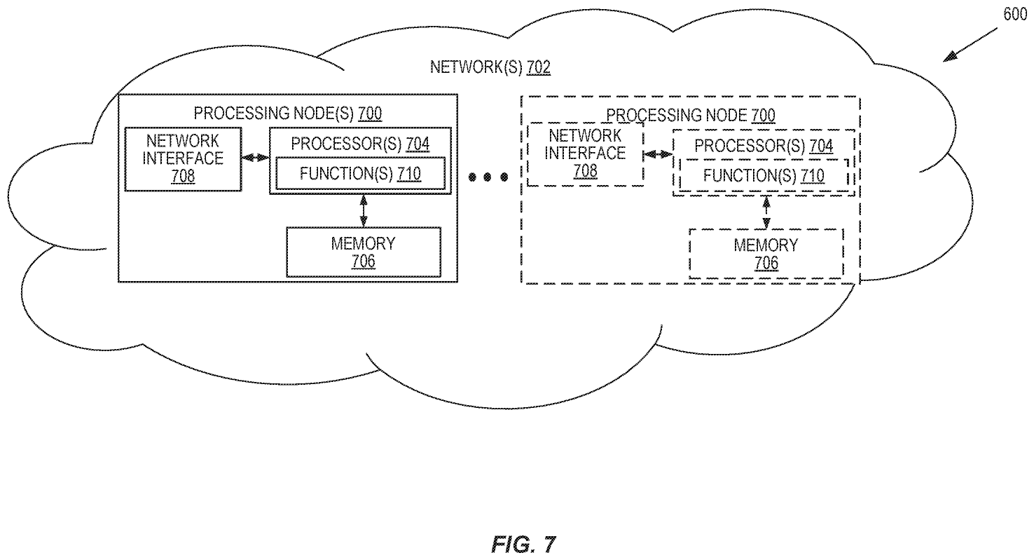

FIG. 9 is a schematic block diagram of a UE 900 according to some embodiments of the present disclosure. As illustrated, the UE 900 includes one or more processors 902 (e.g., CPUs, ASICs, FPGAs, and/or the like), memory 904, and one or more transceivers 906 each including one or more transmitters 908 and one or more receivers 910 coupled to one or more antennas 912. The transceiver(s) 906 includes radio-front end circuitry connected to the antenna(s) 912 that is configured to condition signals communicated between the antenna(s) 912 and the processor(s) 902, as will be appreciated by one of ordinary skill in the art. The processor(s) 902 are also referred to herein as processing circuitry. The transceiver(s) 906 are also referred to herein as radio circuitry. In some embodiments, the functionality of the UE 900 described above may be fully or partially implemented in software that is, e.g., stored in the memory 904 and executed by the processor(s) 902. Note that the UE 900 may include additional components not illustrated in FIG. 9 such as, e.g., one or more user interface components (e.g., an input/output interface including a display, buttons, a touch screen, a microphone, a speaker(s), and/or the like and/or any other components for allowing input of information into the UE 900 and/or allowing output of information from the UE 900), a power supply (e.g., a battery and associated power circuitry), etc.

In some embodiments, a computer program including instructions which, when executed by at least one processor, causes the at least one processor to carry out the functionality of the UE 900 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

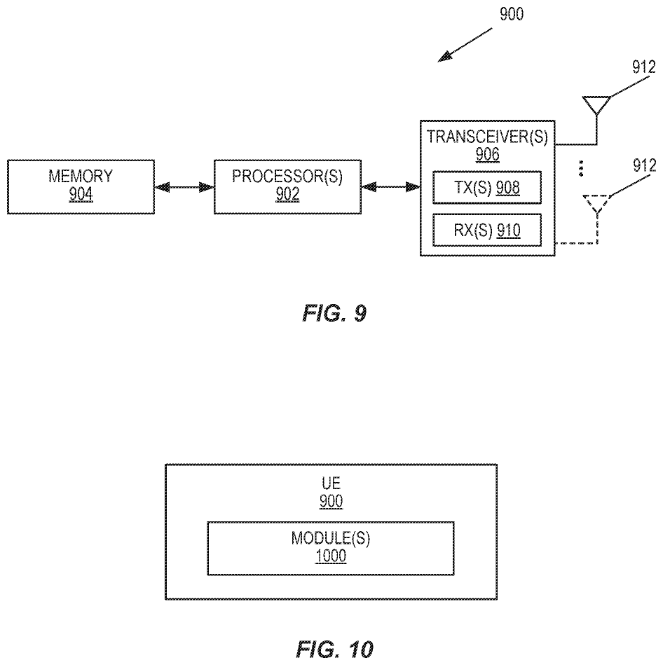

FIG. 10 is a schematic block diagram of the UE 900 according to some other embodiments of the present disclosure. The UE 900 includes one or more modules 1000, each of which is implemented in software. The module(s) 1000 provide the functionality of the UE 900 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

While not being limited thereto, some example embodiments of the present disclosure are provided below.

### Embodiment 1

A method performed in a core network of a cellular communications system to avoid transmission of unnecessary session management, SM, messages, the method comprising:
at a radio access network, RAN, (300):
   determining (528) that a non-access stratum, NAS, message carrying a Protocol Data Unit, PDU, session establishment accept indication was not sent to a user equipment, UE, (212); and
   sending (528), to an Access and Mobility Management Function, AMF, (302), an N2 PDU session request acknowledgment indication comprising a cause indicating that the NAS message carrying the PDU session establishment accept indication was not sent to the UE (212);
at the AMF (302):
   receiving (528), from the RAN (300), the N2 PDU session request acknowledgment indication comprising the cause; and
   sending (530) an Nsmf_PDUSession_UpdateSMContext request comprising the cause to a Session Management Function, SMF, (310); and
at the SMF (310):
   determining (536) that the NAS message carrying the PDU session establishment accept indication was not sent to the UE (212) by the RAN (300); and
   responsive to determining that the NAS message carrying the PDU session establishment accept indication was not sent to the UE (212), sending (536) a PDU session establishment reject indication to the UE.

### Embodiment 2

A method performed by a Session Management Function, SMF, (310) in a core network (210) of a cellular communications system (200) to avoid transmission of unnecessary session management, SM, messages, the method comprising:
determining (536) that a non-access stratum, NAS, message carrying a Protocol Data Unit, PDU, session establishment accept indication was not sent to a User Equipment, UE, (212) by a radio access network, RAN, (300); and responsive to determining (536) that the NAS message carrying the PDU session establishment accept indication was not sent to the UE (212), sending (536) a PDU session establishment reject indication to the UE (212).

### Embodiment 3

The method of embodiment 2, wherein determining that the NAS message carrying the PDU session establishment accept indication was not sent to the UE (212) comprises:
receiving (530), from an Access and Mobility Management Function, AMF, (302), an Nsmf_PDUSession_UpdateSMContext request comprising a cause; and
determining (536) that the NAS message carrying the PDU session establishment accept indication was not sent to the UE (212) based on the cause.

### Embodiment 4

The method of embodiment 2, wherein sending (536) the PDU session establishment reject indication to the UE (212) comprises sending (536) an Namf_Communication_N1N2MessageTransfer comprising the PDU session establishment reject indication to the AMF (302).

### Embodiment 5

A Session Management Function, SMF, (310) for a core network (210) of a cellular communications system (200) enabled to avoid transmission of unnecessary session management, SM, messages, the SMF (310) adapted to:
determine (536) that a non-access stratum, NAS, message carrying a Protocol Data Unit, PDU, session establishment accept indication was not sent to a User Equipment, UE, (212) by a radio access network (300); and
send (536) a PDU session establishment reject indication to the UE responsive to determining (536) that the NAS message carrying the PDU session establishment accept indication was not sent to the UE (212).

### Embodiment 6

The SMF (310) of embodiment 5 wherein the SMF (310) is further adapted to perform the method of any one of embodiments 3 to 4.

### Embodiment 7

A network node (600) for implementing a Session Management Function, SMF, (310) for a core network (210) of a cellular communications system (200) where the SMF (310) is enabled to avoid transmission of unnecessary session management, SM, messages, the network node (600) comprising:
a network interface (608); and
processing circuitry (604) associated with the network interface (608), the processing circuitry (604) adapted to cause the network node (600) to implement the SMF (310) such that the SMF (310) is configured to:
   determine (536) that a non-access stratum, NAS, message carrying a Protocol Data Unit, PDU, session establishment accept indication was not sent to a User Equipment, UE, (212) by a radio access network (300); and
   send (536) a PDU session establishment reject indication to the UE responsive to determining (536) that the NAS message carrying the PDU session establishment accept indication was not sent to the UE (212).

### Embodiment 8

The network node (600) of embodiment 7 wherein the processing circuitry (604) is adapted to cause the network node (600) to implement the SMF (310) such that the SMF (310) is further configured to perform the method of any one of embodiments 3 to 4.

### Embodiment 9

A method performed by a radio access network, RAN, (300) in a core network (210) of a cellular communications system (200) to avoid transmission of unnecessary session management, SM, messages, the method comprising:
determining (528) that a non-access stratum, NAS, message carrying a Protocol Data Unit, PDU, session establishment accept indication was not sent to a user equipment, UE, (212); and
sending (528), to an Access and Mobility Management Function, AMF, (302), an N2 Protocol Data Unit, PDU, session request acknowledgment indication comprising a cause indicating that the NAS message carrying the PDU session establishment accept indication was not sent to the UE (212).

### Embodiment 10

The method of embodiment 9, further comprising:
receiving (538) a PDU session establishment reject indication from the AMF (302); and
sending (540) the PDU session establishment reject indication to the UE (212) using access network signaling.

### Embodiment 11

A radio access network, RAN, (300) for a core network (210) of a cellular communications system (200) enabled to avoid transmission of unnecessary session management, SM, messages, the RAN (300) adapted to:
determine (528) that a non-access stratum, NAS, message carrying a Protocol Data Unit, PDU, session establishment accept indication was not sent to a user equipment, UE, (212); and
send (528), to an Access and Mobility Management Function, AMF, (302), an N2 Protocol Data Unit, PDU, session request acknowledgment indication comprising a cause indicating that the NAS message carrying the PDU session establishment accept indication was not sent to the UE (212).

### Embodiment 12

The RAN (300) of embodiment 11 wherein the RAN (300) is further adapted to perform the method of embodiment 9.

### Embodiment 13

A network node (600) for implementing a radio access network, RAN, (300) for a core network (210) of a cellular communications system (200) where the RAN (300) is enabled to avoid transmission of unnecessary session management, SM, messages, the network node (600) comprising:
a network interface (608); and
processing circuitry (604) associated with the network interface (608), the processing circuitry (604) adapted to cause the network node (600) to implement the RAN (300) such that the RAN (300) is configured to:
   a determine (528) that a non-access stratum, NAS, message carrying a Protocol Data Unit, PDU, session establishment accept indication was not sent to a user equipment, UE, (212); and
   send (528), to an Access and Mobility Management Function, AMF, (302), an N2 Protocol Data Unit, PDU, session request acknowledgment indication comprising a cause indicating that the NAS message carrying the PDU session establishment accept indication was not sent to the UE (212).

### Embodiment 14

The network node (600) of embodiment 13 wherein the processing circuitry (604) is adapted to cause the network node (600) to implement the RAN (300) such that the RAN (300) is further configured to perform the method of embodiment 9.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Management Function
AN Access Network
API Application Program Interface
AS Access Stratum
ASIC Application Specific Integrated Circuit
AUSF Authentication Server Function
CP Control Plane
CPU Central Processing Unit
DN Data Network
DNN Data Network Name
DoNAS Data of Non-Access Stratum
DSP Digital Signal Processor
eNB Enhanced or Evolved Node B
EPC Evolved Packet Core
FPGA Field Programmable Gate Array
gNB New Radio Base Station
HPLMN Home Public Land Mobile Network
H-SMF Home Session Management Function
H-UPF Home User Plane Function
ID Identifier
IoT Internet of Things
IP Internet Protocol
IWF-NEF Interworking Network Exposure Function
LTE Long Term Evolution
MME Mobility Management Entity
MTC Machine Type Communication
NEF Network Exposure Function
NF Network Function
NIDD Non-Internet Protocol Data Delivery
NR New Radio
NRF Network Repository Function
NSSF Network Slice Selection Function
PCF Policy Control Function
PDU Packet Data Unit
P-GW Packet Data Network Gateway
PLMN Public Land Mobile Network
QoS Quality of Service
RAM Random Access Memory
RAN Radio Access Network
ROM Read Only Memory
RRH Remote Radio Head
RTT Round Trip Time
SCEF Service Capability Exposure Function
SCS Service Capability Server
SMF Session Management Function
S-NSSAI Single Network Slice Selection Assistance Information
SUPI Subscriber Permanent Identifier
TR Technical Report
TS Technical Specification
UDM Unified Data Management
UE User Equipment
UP User Plane
UPF User Plane Function
VPLMN Visited Public Land Mobile Network
V-SMF Visited Session Management Function
V-UPF Visited User Plane Function

Those skilled in the art will recognize improvements and modifications to the embodiments of the present disclosure. All such improvements and modifications are considered within the scope of the concepts disclosed herein.

1. A method performed in a core network of a cellular communications system to avoid transmission of unnecessary session management, SM, messages, the method comprising:
at a radio access network, RAN:
determining that a non-access stratum, NAS, message carrying a Protocol Data Unit, PDU, session establishment accept indication was not sent to a user equipment, UE; and
sending, to an Access and Mobility Management Function, AMF, an N2 PDU session request acknowledgment indication comprising a cause indicating that the NAS message carrying the PDU session establishment accept indication was not sent to the UE;
at the AMF:
receiving, from the RAN, the N2 PDU session request acknowledgment indication comprising the cause; and
sending an Nsmf_PDUSession_UpdateSMContext request comprising the cause to a Session Management Function, SMF; and
at the SMF:
determining that the NAS message carrying the PDU session establishment accept indication was not sent to the UE by the RAN; and
responsive to determining that the NAS message carrying the PDU session establishment accept indication was not sent to the UE, sending a PDU session establishment reject indication to the UE to prevent the UE from retransmitting an SM message to request a PDU session establishment.

2. A method performed by a Session Management Function, SMF, in a core network of a cellular communications system to avoid transmission of unnecessary session management, SM, messages, the method comprising:
determining that a non-access stratum, NAS, message carrying a Protocol Data Unit, PDU, session establishment accept indication was not sent to a User Equipment, UE, by a radio access network, RAN; and
responsive to determining that the NAS message carrying the PDU session establishment accept indication was not sent to the UE, sending a PDU session establishment reject indication to the UE to prevent the UE from retransmitting an SM message to request a PDU session establishment.

3. The method of claim 2, wherein determining that the NAS message carrying the PDU session establishment accept indication was not sent to the UE comprises:
receiving, from an Access and Mobility Management Function, AMF, an Nsmf_PDUSession_UpdateSMContext request comprising a cause; and
determining that the NAS message carrying the PDU session establishment accept indication was not sent to the UE based on the cause.

4. The method of claim 2, wherein sending the PDU session establishment reject indication to the UE comprises sending an Namf_Communication_N1N2MessageTransfer comprising the PDU session establishment reject indication to the AMF.

5. (canceled)

6. (canceled)

7. A network node for implementing a Session Management Function, SMF, for a core network of a cellular communications system where the SMF is enabled to avoid transmission of unnecessary session management, SM, messages, the network node comprising:
a network interface; and
processing circuitry associated with the network interface, the processing circuitry adapted to cause the network node to implement the SMF such that the SMF is configured to:
determine that a non-access stratum, NAS, message carrying a Protocol Data Unit, PDU, session establishment accept indication was not sent to a User Equipment, UE, by a radio access network; and
send a PDU session establishment reject indication to the UE responsive to determining that the NAS message carrying the PDU session establishment accept indication was not sent to the UE to prevent the UE from retransmitting an SM message to request a PDU session establishment.

8. The network node of claim 7 wherein the processing circuitry is adapted to cause the network node to implement the SMF such that the SMF is further configured to, in order to determine that the NAS message carrying the PDU session establishment accept indication was not sent to the UE:
receive, from an Access and Mobility Management Function, AMF, an Nsmf_PDUSession_UpdateSMContext request comprising a cause; and
determining that the NAS message carrying the PDU session establishment accept indication was not sent to the UE based on the cause.

9. A method performed by a radio access network, RAN, in a core network of a cellular communications system to avoid transmission of unnecessary session management, SM, messages, the method comprising:
determining that a non-access stratum, NAS, message carrying a Protocol Data Unit, PDU, session establishment accept indication was not sent to a user equipment, UE; and
sending, to an Access and Mobility Management Function, AMF, an N2 Protocol Data Unit, PDU, session request acknowledgment indication comprising a cause indicating that the NAS message carrying the PDU session establishment accept indication was not sent to the UE.

10. The method of claim 9, further comprising:
receiving a PDU session establishment reject indication from the AMF; and
sending the PDU session establishment reject indication to the UE using access network signaling.

11. (canceled)

12. (canceled)

13. A network node for implementing a radio access network, RAN, for a core network of a cellular communications system where the RAN is enabled to avoid transmission of unnecessary session management, SM, messages, the network node comprising:
a network interface; and
processing circuitry associated with the network interface, the processing circuitry adapted to cause the network node to implement the RAN such that the RAN is configured to:
determine that a non-access stratum, NAS, message carrying a Protocol Data Unit, PDU, session establishment accept indication was not sent to a user equipment, UE; and
send, to an Access and Mobility Management Function, AMF, an N2 Protocol Data Unit, PDU, session request acknowledgment indication comprising a cause indicating that the NAS message carrying the PDU session establishment accept indication was not sent to the UE.

14. The network node of claim 13 wherein the processing circuitry is adapted to cause the network node to implement the RAN such that the RAN is further configured to:
receive a PDU session establishment reject indication from the AMF; and
send the PDU session establishment reject indication to the UE using access network signaling.

15. The network node of claim 7 wherein the processing circuitry is adapted to cause the network node to implement the SMF such that the SMF is further configured to, in order to send the PDU session establishment reject indication to the UE, sending an Namf_Communication_N1N2MessageTransfer comprising the PDU session establishment reject indication to the AMF.
